(19) United States
(12) Patent Application Publication
(10) Pub. No.: US 2025/0342648 A1
(43) Pub. Date: Nov. 6, 2025

(54) INFORMATION PROCESSING DEVICE, INFORMATION PROCESSING METHOD, AND COMPUTER-READABLE NON-TRANSITORY STORAGE MEDIUM

(71) Applicant: SONY GROUP CORPORATION, TOKYO (JP)

(72) Inventor: DAISUKE IRIE, TOKYO (JP)

(21) Appl. No.: 18/870,758

(22) PCT Filed: May 29, 2023
(86) PCT No.: PCT/JP2023/019890

§ 371 Date: Dec. 2, 2024

(30) Foreign Application Priority Data
Jun. 8, 2022 (JP) 2022-093306

(51) Int. Cl. G06T 15/06; G06T 3/40; G06T 5/70

(52) U.S. Cl. CPC G06T 15/06; G06T 3/40; G06T 5/70; G06T 2207/20182

(57) ABSTRACT

An information processing device includes a learning data acquisition processing unit. The learning data acquisition processing unit sequentially acquires, from a ray tracer, ray sample data generated by ray simulation by the ray tracer. The learning data acquisition processing unit reconstructs the ray sample data sequentially acquired from the ray tracer, and generates learning data of an inference model. The learning data includes a student image and a teacher image for learning the inference model.

### FIELD

The present invention relates to an information processing device, an information processing method, and a computer-readable non-transitory storage medium.

### BACKGROUND

In rendering of a ray-trace method, speeding up using a deep neural network (DNN) denoiser is effective to shorten processing time. However, in a case where a data characteristic at the time of prior learning by the DNN is different from that at the time of actual operation, sufficient performance cannot be exhibited.

### CITATION LIST

### Patent Literature

Patent Literature 1: Japanese Patent Application Laid-Open No. 2020-109620

### SUMMARY

### Technical Problem

In order to cope with the above problem, a method of updating a learning coefficient of a DNN by online learning is conceivable. For example, Patent Literature 1 proposes a method of adding a teacher image of a high sample per pixel (spp) and performing relearning. However, this method increases a calculation cost for rendering of high spp.

Thus, the present disclosure proposes an information processing device, an information processing method, and a computer-readable non-transitory storage medium capable of controlling a calculation cost for learning.

### Solution to Problem

According to the present disclosure, an information processing device is provided that comprise a learning data acquisition processing unit that sequentially acquires ray sample data generated by ray simulation by a ray tracer from the ray tracer, and reconstructs the ray sample data and generates learning data including a student image and a teacher image for learning of an inference model. According to the present disclosure, an information processing method in which an information process of the information processing device is executed by a computer, and a computer-readable non-transitory storage medium that stores a program causing a computer to perform the information process of the information processing device, are provided.

### BRIEF DESCRIPTION OF DRAWINGS

FIG. 1 is a view illustrating an example of a rendering system of the present disclosure.

FIG. 2 is a view illustrating an example of a conventional rendering system.

FIG. 3 is a view illustrating another example of a conventional rendering system.

FIG. 4 is a flowchart illustrating an example of a processing flow related to learning and inference.

FIG. 5 is a flowchart illustrating an example of a processing flow related to learning and inference.

FIG. 6 is a view for describing a relationship between a pixel grid, and resolution and an spp value.

FIG. 7 is a view for describing features of learning and inference in super-resolution processing.

FIG. 8 is a view for describing features of learning and inference in denoise.

FIG. 9 is a view for describing an adjustment method of the spp value by accumulation of ray samples.

FIG. 10 is a view for describing the adjustment method of the spp value by accumulation of the ray samples.

FIG. 11 is a view for describing the adjustment method of the spp value by accumulation of the ray samples.

FIG. 12 is a view for describing the adjustment method of the spp value by accumulation of the ray samples.

FIG. 13 is a view for describing a method of generating a large number of student images from a same scene.

FIG. 14 is a view illustrating an example of learning and inference using rendered data for a viewport.

FIG. 15 is a view illustrating an example of learning and inference using rendered data for a viewport.

FIG. 16 is a flowchart illustrating an example of a generation flow of learning data.

FIG. 17 is a view for describing a setting method of a learning condition and an inference condition.

FIG. 18 is a view for describing the setting method of the learning condition and the inference condition.

FIG. 19 is a view illustrating a hardware configuration example of a renderer.

### DESCRIPTION OF EMBODIMENTS

In the following, embodiments of the present disclosure will be described in detail on the basis of the drawings. In each of the following embodiments, overlapped description is omitted by assignment of the same reference sign to the same parts.

Note that the description will be made in the following order.
[1. Background]
[2. Configuration of a rendering system]
[3. Information processing method]
[4. Generation method of learning data]
[4-1. Relationship between a pixel grid and resolution/spp value]
[4-2. Features of learning and inference of a DNN]
[4-3. Adjustment of an spp value by accumulation of ray samples]
[4-4. Large number of student images generated from a same scene]
[4-5. Inference processing using a learning result]
[4-6. Generation flow of learning data]
[5. Automatic setting of a learning condition and an inference condition]
[6. Hardware configuration example]
[7. Effect]

### 1. BACKGROUND

In a rendering system using a ray tracing method (such as CG renderer, online game, or rendering farm), a large amount of ray simulation is performed, and thus rendering takes long time. Thus, rendering is performed at a high speed with a low spp value such as a several spp to several tens of spp, and noise generated at that time is denoised as post processing to shorten the processing time. Recently, effectiveness of denoise using a DNN is specifically high, and prior learning based on various kinds of content and spp settings is generally performed in order to satisfy various kinds of required performance.

On the other hand, the DNN cannot exhibit sufficient performance for data characteristics (such as a noise pattern, magnitude of noise dispersion, color and luminance distribution of a subject, and the like) that are not learned in advance.

Specifically, in ray tracing, various noise characteristics are generated depending on characteristics of content (such as intensity of lighting, and bidirectional reflectance distribution function of a subject). Thus, there is a possibility that residual noise is generated or details are flattened more than necessary due to a mismatch between a learning coefficient created in advance and a noise characteristic to be denoised. Ideally, it is desirable that a result of rendering of content to be rendered at a specific low spp value is learned and denoise of a rendering result of the same content at the same spp value is performed.

In order to solve this problem, it is conceivable to use technique called online learning. Online learning means a method of performing learning in a background (one is cloud processing, and the other is processing using a local partial thread/memory region). For example, in an online game, a high-spp image corresponding to the video is separately generated while a video rendered at high speed with “low spp+denoise” is provided to a user, and online learning of a correspondence between the low-spp image and the high-spp image is performed. In a renderer having a viewport ray tracing function, a video rendered for a viewport can be utilized for learning.

Patent Literature 1 proposes a method of acquiring a part of a low-spp rendered image as a small region and selectively performing high-spp rendering on the small region. Rendering at high spp is required to create training data. Rendering at high spp generally causes a high calculation load. However, by limiting a rendering target to the small region instead of the entire image, the calculation cost can be controlled. Note that when rendering is limited to the small region, rendering of a considerable number of frames is required in order to secure a sufficient amount of learning data. Thus, Patent Literature 1 proposes to perform rendering by a distributed host machine and to shorten time required for data construction.

Furthermore, as a method of speeding up rendering, not only a method of denoising a low-spp image but also a method of performing super-resolution processing of a low resolution image can be considered. For example, it is also effective to perform rendering with a low number of pixels such as 1K or 2K and to perform super-resolution to around 4K in post-processing. In this case, in the method of Patent Literature 1, it is necessary to newly render training data with high spp and high resolution. For example, in a case where super-resolution from 1K to 4K is simultaneously learned, it is necessary to further pay a rendering cost of 4×4=16 times. When a rendering region of a teacher is narrowed to control the rendering cost, the number of required rendering frames increases, and long time is eventually required for a learning process or the number of distributed host machines needs to be increased.

In a case where immediacy is not required for an update frequency of a system as in an online game, or in a case where a large number of calculation resources (such as distributed host machine and parallel GPU) can be allocated to single piece of content, there is a possibility that the above-described processing can be applied. However, in general rendering applications represented by CG production of a movie, a game, and the like, immediacy is required since rendered content changes sequentially. Furthermore, it is not realistic to provide a large number of calculation resources for each of the infinite number of users. In such a case, it is desirable to immediately acquire learning data and advance learning of a DNN without performing additional rendering for acquiring training data.

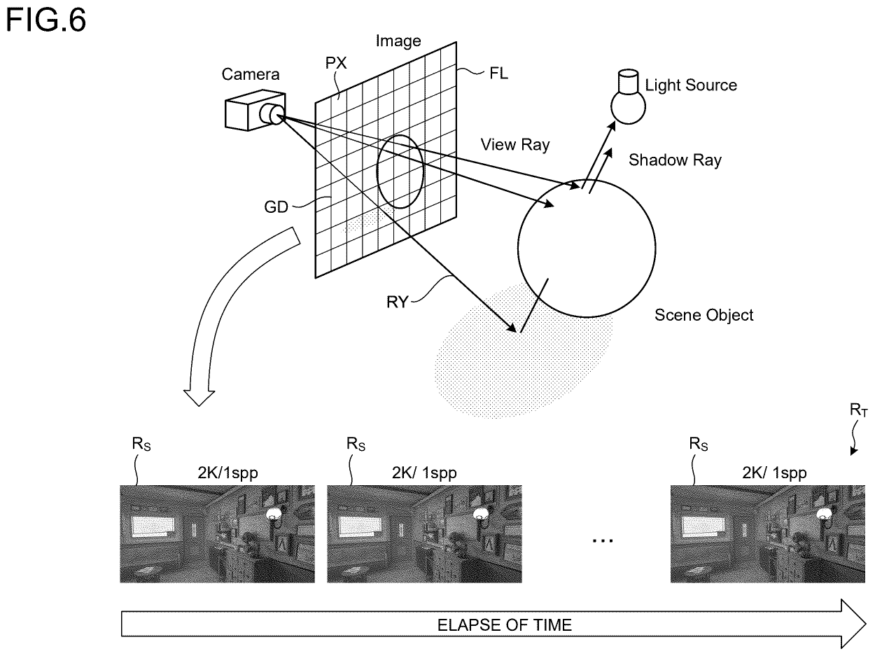

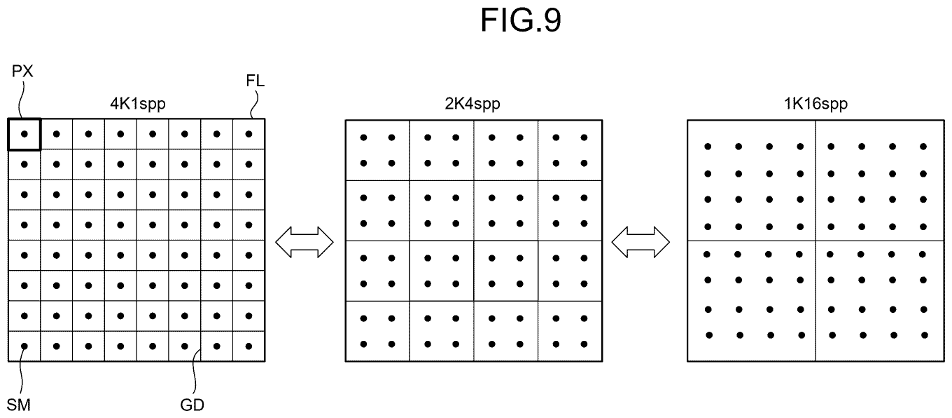

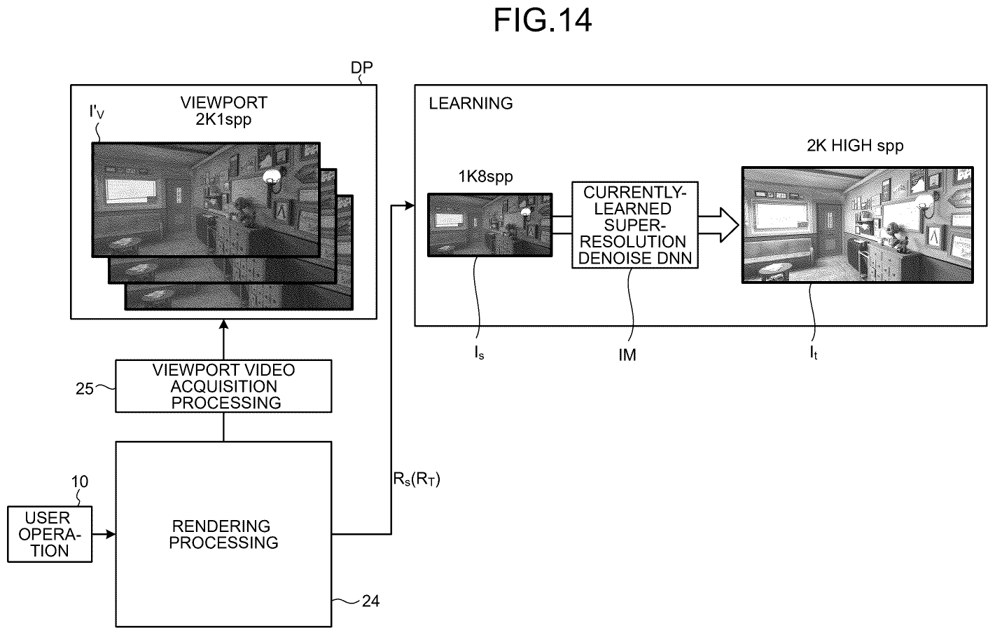

Thus, the present disclosure proposes technique of generating learning data without performing additional rendering. In the present disclosure, ray tracing data R_{T} (see FIG. 6) acquired in a middle of generation of a viewport video or the like is reconstructed and learning data (teacher image Iₜ and student image Iₛ: see FIG. 14) is generated. The reconstruction means that a size of a pixel grid GD (see FIG. 9) used for image generation and a degree of accumulation of the ray sample data Rₛ (see FIG. 6) are adjusted in such a manner that the desired resolution and spp value are acquired.

The ray tracing data R_{T} includes ray sample data Rₛ of a plurality of frames output in time series. In the present disclosure, the teacher image It and the student image Iₛ are generated by accumulation of the ray sample data Rₛ of a plurality of frames having no variation in a viewpoint. The size of the pixel grid GD and the degree of accumulation of the ray sample data Rₛ are made to vary between the teacher image Iₜ and the student image Iₛ, whereby the teacher image Iₜ and the student image Iₛ having the arbitrary resolution and spp value are generated. In this method, since new rendering processing for learning is not required, the calculation cost is reduced. Hereinafter, a specific description will be made.

### 2. CONFIGURATION OF A RENDERING SYSTEM

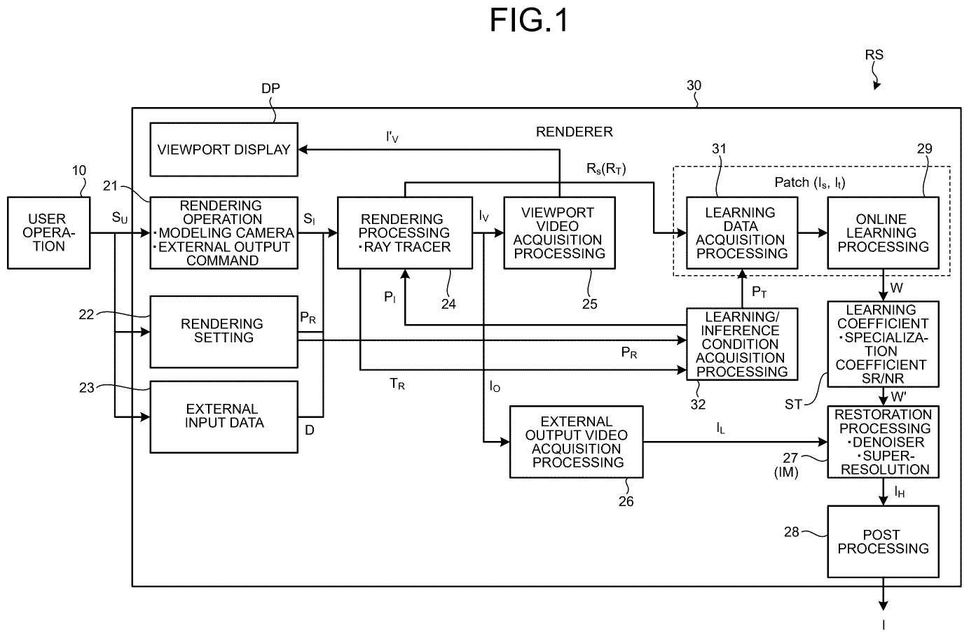

FIG. 1 is a view illustrating an example of a rendering system RS of the present disclosure.

The rendering system RS improves image quality of a low-quality rendered image by image processing (such as denoise or super-resolution processing), and outputs the image. In the example of FIG. 1, a rendering system RSA having a viewport ray tracing function is illustrated. The viewport ray tracing function means a function of displaying a result of ray tracing performed for generation of previsualization or the like in real time on a viewport. The rendering system RS reconstructs the ray sample data Rₛ generated for a viewport video, and generates learning data of an inference model IM.

The rendering system RS includes a user operation unit 10 and a renderer 30. The user operation unit 10 receives user operation via a mouse, a keyboard, a controller, and the like. The user operation unit 10 converts the user operation into an input signal S_{U} and supplies the input signal S_{U} to the renderer 30. The user operation includes, for example, rendering operation, and operation on rendering setting and a 3D model D.

The renderer 30 is an information processing device that processes various kinds of information necessary for rendering. The renderer 30 includes a rendering operation unit 21, a rendering setting unit 22, an external input data acquisition unit 23, a rendering processing unit 24, a viewport video acquisition processing unit 25, an external output video acquisition processing unit 26, a restoration processing unit 27, a post-processing unit 28, an online learning processing unit 29, a learning data acquisition processing unit 31, a learning/inference condition acquisition processing unit 32, a viewport display unit DP, and a learning coefficient storage unit ST.

The rendering operation unit 21 defines a position, movement, and the like of a viewpoint in a 3D space on the basis of the input signal S_{U}. The rendering operation unit 21 converts the defined information into a rendering operation signal S_{I} and performs transmission thereof to the rendering processing unit 24. In response to an instruction of the input signal S_{U}, the rendering operation unit 21 transmits an external output command of a still image or a moving image format of currently-created content to the rendering processing unit 24.

The rendering setting unit 22 holds setting values (rendering setting values P_{R}) of various parameters related to ray tracing on the basis of the input signal S_{U}. The rendering set value P_{R} includes, for example, setting values related to a shadow, global illumination, reflection, transmission validity, the number of bounces, the number of spp, a camera setting of rendering for an external output video (actual rendering), and the like. The rendering setting value P_{R} may include a setting value that defines target rendering time (target rendering execution time).

On the basis of the input signal S_{U}, the external input data acquisition unit 23 acquires external input data from an external device, and transmits the acquired external input data to the rendering processing unit 24. The external input data includes data of content to be rendered. For example, the external input data acquisition unit 23 inputs the 3D model D such as a mesh or texture data to the rendering processing unit 24 on the basis of the input signal S_{U}. A user can perform general editing work such as changing of a shape and texture of the model on the renderer 30.

The rendering processing unit 24 renders the 3D model D on the basis of a viewpoint position determined by the rendering operation signal S_{I} and the set values of the various parameters defined in the rendering set value P_{R}. As a rendering method, a method that requires ray simulation, such as ray tracing, path tracing, and photon mapping is used.

The rendering processing unit 24 functions as a ray tracer that generates the ray sample data R_{S} for each frame. For example, the rendering processing unit 24 emits a large number of rays RY (see FIG. 6) onto the 3D space from the viewpoint position, and acquires an image of each of the rays RY on a two-dimensional plane as a ray sample SM (see FIG. 9). The rendering processing unit 24 acquires values related to color and luminance of the ray samples SM as ray sample values. The rendering processing unit 24 acquires a distribution of the ray sample values on the two-dimensional plane as the ray sample data R_{S}.

The rendering processing unit 24 sets the pixel grid GD on the two-dimensional plane on the basis of the rendering setting value P_{R}. The rendering processing unit 24 performs processing of accumulating the ray samples SM for each pixel PX (see FIG. 9) partitioned by the pixel grid GD. The rendering processing unit 24 statistically processes the ray sample values of the plurality of accumulated ray samples SM. The rendering processing unit 24 calculates an average ray sample value (such as a mean, median, or mode) acquired by statistical processing as a pixel value. The rendering processing unit 24 outputs an image acquired by the accumulation processing of the ray samples SM as a rendered image I_{V}.

The rendering processing is continuously performed. The rendering processing unit 24 keeps transmitting the rendered image I_{V} to the viewport video acquisition processing unit 25. The viewport video acquisition processing unit 25 sequentially receives the low-spp (such as 1-spp) rendered image I_{V} successively output in units of frames from the rendering processing unit 24.

In a case where the viewpoint does not move and is constant, the viewport video acquisition processing unit 25 performs time integration of the rendered images I_{V} of a plurality of consecutive frames related to the same viewpoint. By the time integration, an integral image I′_{V} in which the rendered images I_{V} of the plurality of frames are averaged is acquired. The viewport video acquisition processing unit 25 transfers the integral image I′_{V} to the viewport display unit DP. In a case where the viewpoint is moving, the viewport video acquisition processing unit 25 refreshes the time integration, and transfers the low-spp rendered image I_{V} not subjected to the integration processing to the viewport display unit DP.

On a graphical user interface (GUI) screen, the viewport display unit DP displays the rendered image I_{V} or the integral image I′_{V} sequentially transferred from the viewport video acquisition processing unit 25. The user performs a previsualization inspection or the like on the basis of the rendered image I_{V} or the integral image I′_{V} displayed on the GUI screen.

In a case of receiving the external output command from the rendering operation unit 21, the rendering processing unit 24 transfers a rendered image I_{O} based on an inference condition P_{I} to the external output video acquisition processing unit 26. The inference condition P_{I} includes a condition related to resolution and an spp value of an input image input to the inference model IM. The inference condition P_{I} may be manually specified by the user, or may be automatically set on the basis of the target rendering execution time or the like.

The external output video acquisition processing unit 26 applies preprocessing for an external output to the low-resolution and low-spp rendered image I_{O} received from the rendering processing unit 24. For example, conversion into a moving image at a preset frame rate, pre-removal of a high luminance outlier (noise) called a firefly, normalization in accordance with a specification of the DNN of restoration processing, changing of bit precision, and the like are performed as preprocessing. The external output video acquisition processing unit 26 may acquire, from the rendering processing unit 24, additional information of rendering which information can be generally acquired and is useful as information to be input to the restoration processing, such as Albedo or Normal.

The external output video acquisition processing unit 26 transmits an image I_{L} acquired by the preprocessing of the rendered image I_{O} to the restoration processing unit 27. The external output video acquisition processing unit 26 may output the successively generated images I_{L} of the plurality of frames as a moving image.

The restoration processing unit 27 performs restoration processing of the image I_{L} by using the inference model IM. For example, the restoration processing unit 27 acquires, from the learning coefficient storage unit ST, a coefficient (learning coefficient W) of the DNN in which learning of denoise and super-resolution processing has been performed. Note that the DNN includes a large number of parameters optimized by the learning. The “learning coefficient” is a generic term for a parameter group a value of which is determined by machine learning. The restoration processing unit 27 performs the restoration processing of the image I_{L} by using the inference model IM (DNN) to which the learning coefficient W is applied. The restoration processing unit 27 acquires a restored image I_{H} having high resolution and high spp by performing the restoration processing on the image I_{L}.

The post-processing unit 28 applies post processing to the restored image I_{H} and acquires a final output image I. As the post processing, for example, known processing such as changing of a color space, encoding, and format conversion is performed.

The learning/inference condition acquisition processing unit 32 determines a learning condition P_{T} and the inference condition P_{I} from the rendering set value P_{R} and a rendering speed T_{R}. The rendering speed T_{R} means a processing amount of rendering per unit time which processing amount is measured by the rendering processing unit 24.

The learning condition P_{T} includes information related to resolution and an spp value of the teacher image Iₜ and resolution and an spp value of the student image Iₛ in the learning data. For example, the resolution of the teacher image Iₜ matches resolution of the viewport video. The spp value of the teacher image Iₜ is defined as a lower limit value of the spp value for satisfying an allowable standard (required denoise performance). The inference condition P_{I} includes information related to the resolution and the spp value of the input image input to the inference model IM. The learning/inference condition acquisition processing unit 32 transmits the learning condition P_{T} to the learning data acquisition processing unit 31 and transmits the inference condition P_{I} to the rendering processing unit 24.

The rendering processing unit 24 transfers the ray sample data Rₛ that is before imaging and that corresponds to an intermediate product to the learning data acquisition processing unit 31 while continuously generating the rendered image I_{V}. The learning data acquisition processing unit 31 sequentially acquires, from the rendering processing unit 24, the ray sample data Rₛ (ray tracing data R_{T}) generated by the ray simulation by the rendering processing unit 24. The learning data acquisition processing unit 31 reconstructs the ray sample data Rₛ, which is sequentially acquired from the rendering processing unit 24, on the basis of the learning condition P_{T} and generates learning data of the inference model IM. The learning data includes the student image Iₛ and the teacher image Iₜ for learning of the inference model IM.

The learning data acquisition processing unit 31 generates a large number of pairs of teacher images Iₜ and student images Iₛ from the ray tracing data R_{T} and performs an output thereof as the learning data. In a case where the inference model IM performs denoise and super-resolution processing, a combination of a low-resolution and low-spp student image Iₛ and a high-resolution and high-spp teacher image Iₜ is generated as the learning data of the inference model IM. The teacher image Iₜ and the student image Iₛ are generated as, for example, patch images. The learning data acquisition processing unit 31 supplies a learning data patch including a large number of pairs of the patch images to the online learning processing unit 29 as the learning data.

The online learning processing unit 29 learns the inference model IM by using the learning data acquired from the learning data acquisition processing unit 31. The learning here means fine tuning of a learned coefficient with general-purpose data. The general-purpose data means highly versatile learning data including various kinds of CG content accumulated before production of the external output video. The online learning processing unit 29 performs fine-tuning of the inference model learned with the general-purpose data on the basis of learning data newly acquired by reconstruction of the ray sample data Rₛ.

For example, the online learning processing unit 29 extracts, from the learning data, a plurality of student images Iₛ and a plurality of teacher images Iₜ having viewpoint information similar to viewpoint information used for generation of the external output video. The online learning processing unit 29 performs fine tuning of the inference model IM by preferentially using the extracted plurality of student images Iₛ and plurality of teacher images Iₜ. The online learning processing unit 29 can use a desired DNN model and hyperparameter in learning.

At an initial stage of system driving, a learning coefficient W (initial coefficient) optimized in advance with general-purpose data is used. As the system is driven, the online learning proceeds, and the learning coefficient W is sequentially updated by a coefficient (specialization coefficient) acquired by relearning. In updating, for example, the online learning processing unit 29 may compare the initial coefficient and the specialization coefficient by an evaluation function (such as PSNR or SSIM) and update the learning coefficient W only in a case where the specialization coefficient is superior. After the update, the online learning processing unit 29 similarly performs performance evaluation between the updated learning coefficient W and the specialization coefficient for which learning is further progressed, and keeps intermittently updating the coefficient with higher performance.

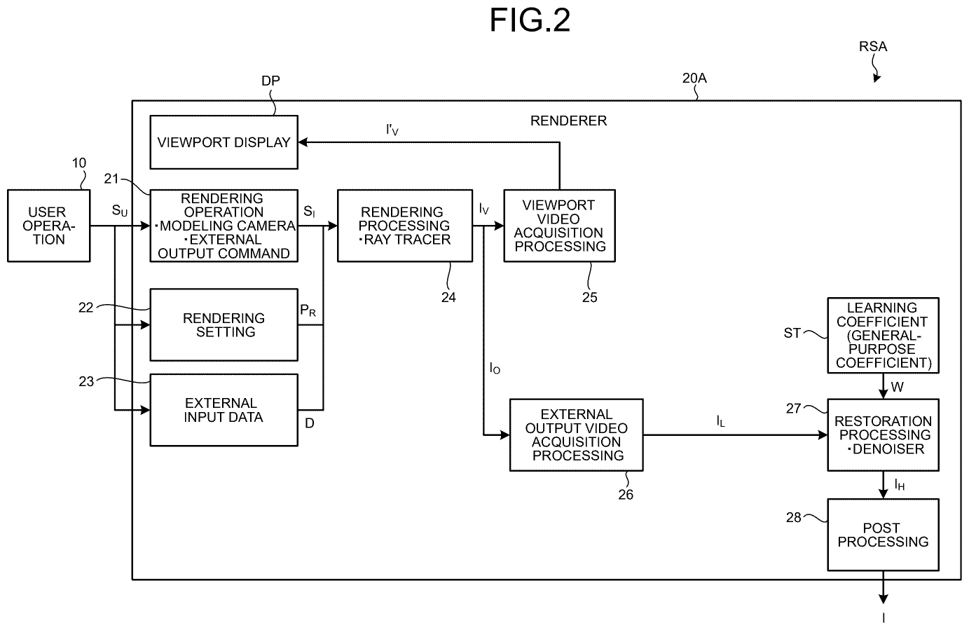

Hereinafter, a conventional rendering system will be described as a comparative example. FIG. 2 is a view illustrating an example of a conventional rendering system (rendering system RSA).

In a renderer 20A of FIG. 2, restoration processing is performed by utilization of a general-purpose inference model IM. The learning coefficient storage unit ST stores a learning coefficient W (general-purpose coefficient) of a DNN learned with general-purpose data. Since the renderer 20A does not perform online learning, the learning coefficient W is not updated. In the restoration processing using the general-purpose coefficient, standard image quality is secured for various kinds of video content. However, there are a wide variety of videos produced at a production site, and sufficient image quality is not necessarily provided for a target video content.

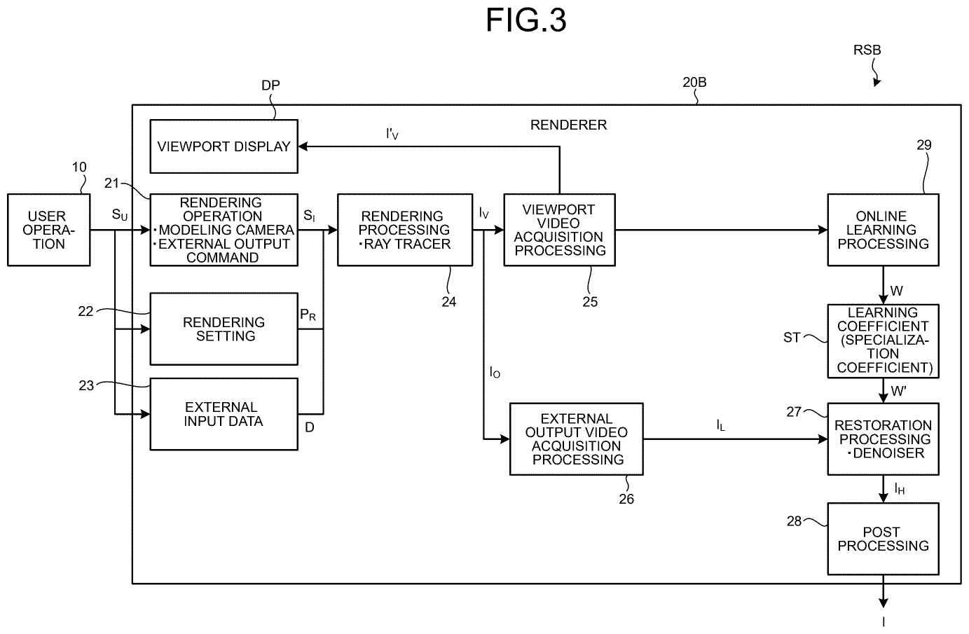

FIG. 3 is a view illustrating another example of a conventional rendering system (rendering system RSB).

In a renderer 20B of FIG. 3, a learning coefficient W is updated as needed by online learning. As learning data, another video (such as a viewport video) that has already been rendered is used. In the example of FIG. 3, a rendered image I_{V} generated for the viewport video is diverted as a student image. However, it is necessary to newly generate a teacher image Iₜ paired with the student image Iₛ. Thus, additional rendering for generating the teacher image Iₜ is necessary.

As described above, in the conventional rendering systems, it is difficult to acquire a high-quality video while controlling a calculation cost. This is because online learning is performed at a high calculation cost in order to improve image quality.

In order to solve such a problem, the present disclosure proposes technique of generating learning data necessary for online learning at low cost. In the present disclosure, ray tracing data generated in a rendering process of another content is reconstructed and learning data (teacher image Iₜ and student image Iₛ) is generated. Since new rendering for generating the learning data is unnecessary, relearning is performed at low calculation cost. Furthermore, the resolution and the spp value of the teacher image Iₜ and the student image Iₛ can be arbitrarily adjusted depending on a manner of reconstruction. Thus, it is possible to freely perform learning with respect to one or both of denoise and super-resolution processing according to a request from a system.

### 3. INFORMATION PROCESSING METHOD

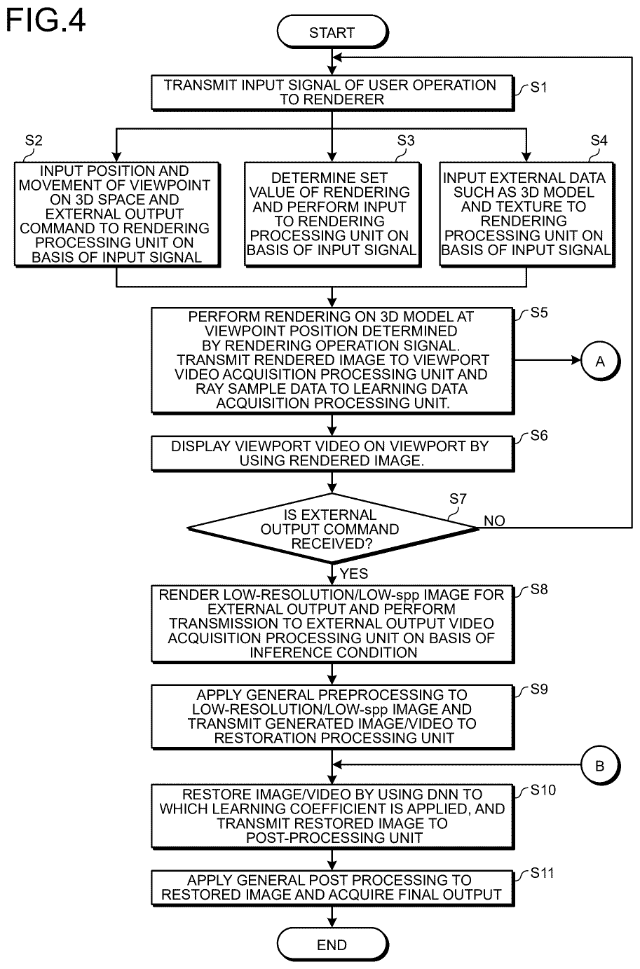

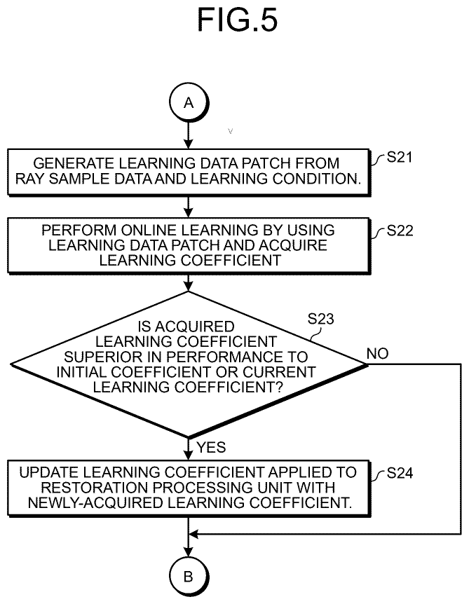

FIG. 4 and FIG. 5 are flowcharts illustrating an example of a processing flow related to learning and inference.

The user operation unit 10 transmits the input signal Su based on the user operation to the renderer 30 (Step S1). The rendering operation unit 21 inputs a position and movement of a viewpoint on the 3D space and the external output command to the rendering processing unit 24 on the basis of the input signal S_{U} (Step S2). The rendering setting unit 22 determines the rendering set value P_{R} on the basis of the input signal S_{U} and inputs the rendering set value P_{R} to the rendering processing unit 24 (Step S3). The external input data acquisition unit 23 inputs external data such as the 3D model or texture to the rendering processing unit 24 on the basis of the input signal S_{U} (Step S4).

The rendering processing unit 24 performs rendering on the 3D model at the viewpoint position determined by the rendering operation signal S_{I}. The rendering processing unit 24 transmits the rendered image I_{V} to the viewport video acquisition processing unit 25. Furthermore, the rendering processing unit 24 transmits the ray sample data Rₛ acquired in the process of generating the rendered image I_{V} to the learning data acquisition processing unit 31 (Step S5).

The viewport video acquisition processing unit 25 displays the viewport video on the viewport by using the rendered image IV (Step S6).

The rendering processing unit 24 determines whether the external output command is received from the rendering operation unit 21 (Step S7). In a case where the external output command is not received (Step S7: No), the processing returns to Step S1, and the above-described processing is repeated until the external output command is received.

In a case where the external output command is received (Step S7: Yes), the rendering processing unit 24 determines a condition of rendering for the external output video (actual rendering) on the basis of the inference condition P_{I}. The rendering processing unit 24 generates the low-resolution and low-spp rendered image I_{O} for the external output on the basis of the determined rendering condition, and transmits the rendered image I_{O} to the external output video acquisition processing unit 26 (Step S8). The inference condition P_{I} may be acquired from the input signal S_{U} of the user, or may be automatically set on the basis of the target rendering execution time or the like.

For example, the learning/inference condition acquisition processing unit 32 calculates the spp value of the input image to be input to the inference model IM on the basis of the rendering speed T_{R} and the target rendering execution time. The learning/inference condition acquisition processing unit 32 can determine the inference condition P_{I} and the learning condition P_{T} on the basis of the calculated spp value of the input image.

The external output video acquisition processing unit 26 applies general preprocessing to the rendered image I_{O}. The external output video acquisition processing unit 26 transmits the image I_{L} acquired by the preprocessing of the rendered image I_{O} to the restoration processing unit 27 (Step S9). The restoration processing unit 27 acquires, from the learning coefficient storage unit ST, the learning coefficient W for which learning of denoise and super-resolution processing is performed, and applies the learning coefficient W to the DNN of the inference model IM. The restoration processing unit 27 restores the image I_{L} by using the inference model IM to which the learning coefficient W is applied. The restoration processing unit 27 transmits the restored image I_{H} that has the high resolution and high spp and that is acquired by the restoration processing of the image I_{L} to the post-processing unit 28 (Step S10). The post-processing unit 28 applies general post processing to the restored image I_{H} and acquires the final output image I (Step S11).

The ray sample data R_{S} acquired in Step S5 is used for generation of the learning data in the learning data acquisition processing unit 31. The learning data acquisition processing unit 31 generates the learning data patch on the basis of the sequentially transmitted ray sample data R_{S} and learning conditions P_{T} (Step S21). The learning condition P_{T} may be acquired from the rendering set value P_{R}, or may be calculated on the basis of the target rendering execution time and the rendering speed T_{R}. The online learning processing unit 29 performs the online learning by using the learning data patch and acquires the relearned (fine-tuned) learning coefficient W (Step S22).

The online learning processing unit 29 determines whether performance of the relearned learning coefficient W is superior to that of the initial coefficient or the current learning coefficient W (Step S23). When the performance is superior (Step S23: Yes), the online learning processing unit 29 determines that the learning is properly performed, and updates the learning coefficient W applied to the restoration processing unit 27 with the learning coefficient W newly acquired by the relearning (Step S24). When the performance is not superior (Step S23: No), the online learning processing unit 29 determines that the learning is not properly performed, and continuously uses the learning coefficient W currently applied to the restoration processing unit 27. The restoration processing in Step S10 is performed on the basis of the learning coefficient W updated as needed by the online learning.

Appropriateness of the learning can be determined by utilization of a part of the learning data. For example, the online learning processing unit 29 uses a part of the learning data as evaluation data. The online learning processing unit 29 evaluates the appropriateness of the learning on the basis of a comparison result between an inference image acquired by an input of the student image Iₛ included in the evaluation data to the inference model IM and the teacher image Iₜ corresponding to the inference image. When image quality of the inference image is higher than that of the teacher image, the online learning processing unit 29 determines that the learning coefficient W acquired by the relearning is superior to the initial coefficient or the current learning coefficient W.

### 4. GENERATION METHOD OF LEARNING DATA

### 4-1. Relationship Between a Pixel Grid and Resolution/Spp Value

Hereinafter, a generation method of the learning data will be specifically described. First, imaging of the pixel grid GD and the ray sample data R_{S} will be described. FIG. 6 is a view for describing a relationship between the pixel grid GD, and the resolution and the spp value.

The rendering processing unit 24 determines a virtual image frame FL on the basis of a position, direction, and focal length of a camera which position, direction, and focal length are defined in the rendering set value P_{R}. On the basis of the resolution and the spp value defined in the rendering set value P_{R}, the rendering processing unit 24 determines the number of rays RY emitted to the image frame FL (total number of pixels×spp value).

The rendering processing unit 24 emits the rays RY in a spatially uniform manner toward a region surrounded by the image frame FL. The rendering processing unit 24 acquires intersection points between a two-dimensional plane surrounded by the image frame FL and the rays RY (image of the rays RY on the two-dimensional plane) as the ray sample SM, and acquires values related to a color and luminance of the ray sample SM as ray sample values. The rendering processing unit 24 acquires a distribution of the ray sample values on the two-dimensional plane as the ray sample data R_{S}. The rendering processing unit 24 generates the ray sample data R_{S} for each frame, and sequentially transmits the generated ray sample data R_{S} to the viewport video acquisition processing unit 25.

The rendering processing unit 24 defines the pixel grid GD on the two-dimensional plane. Each region partitioned by the pixel grid GD is the pixel PX. The number of ray samples SM included in the one pixel PX is the spp value. Since an average ray sample value in the pixel PX is calculated as a pixel value, noise is smaller as the spp value is larger. In the example of FIG. 6, 2048×1080 rays RY corresponding to 2K are emitted. A size of the pixel grid GD (size of the pixel PX) is defined in such a manner that only one ray RY passes through the one pixel PX. As a result, the ray sample data R_{S} of 2K and 1 spp (hereinafter, the resolution and the spp value are combined and described, for example, as “2K1spp”) is generated.

In the present disclosure, the teacher image Iₜ and the student image Iₛ having the desired resolution and spp value are generated by accumulation of the plurality of pieces of ray sample data R_{S} generated for each frame in a time axis direction (frame direction). The resolution and the spp value of the teacher image Iₜ and the student image Iₛ are set on the basis of a relationship between learning and inference due to a characteristic of the DNN.

For example, the learning data acquisition processing unit 31 makes the size of the pixel grid GD applied to the ray sample data R_{S} vary between the student image Iₛ and the teacher image Iₜ. As a result, the learning data acquisition processing unit 31 can make the resolution of the student image Iₛ and that of the teacher image Iₜ different. The learning data acquisition processing unit 31 makes the degree of accumulation of the ray sample data R_{S} in the frame direction vary between the student image Iₛ and the teacher image Iₜ. As a result, the learning data acquisition processing unit 31 can make the spp values of the student image Iₛ and the teacher image Iₜ different.

### 4-2. Features of Learning and Inference of a DNN

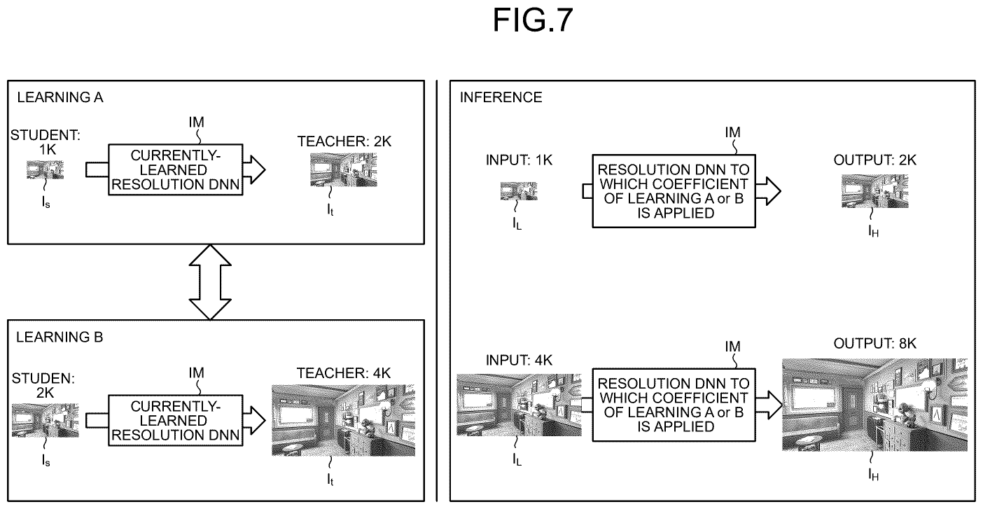

FIG. 7 is a view for describing features of learning and inference in the super-resolution processing.

In the learning of the super-resolution processing, the learning is performed on magnification of the resolution (resolution of the teacher image Iₜ/resolution of the student image Iₛ). Even when the resolution of the data used in the learning is different, the same learning effect can be acquired when a ratio of the resolution of the student image Iₛ and that of the teacher image Iₜ is equal.

For example, when a correspondence relationship between the resolution of the student image Iₛ and that of the teacher image Iₜ is described as [student, teacher], even when [student, teacher] varies like [1K, 2K], [2K, 4K], and [4K, 8K], these are all data for learning the super-resolution processing of twice. As for inference, in the DNN that has learned the super-resolution processing of twice, an output is performed with the resolution being enhanced twice even when an image with any resolution is input to the DNN. Thus, in learning and inference of the super-resolution processing, it is not necessary to make the resolution of the student image Iₛ at the time of learning match the resolution of the input image at the time of inference.

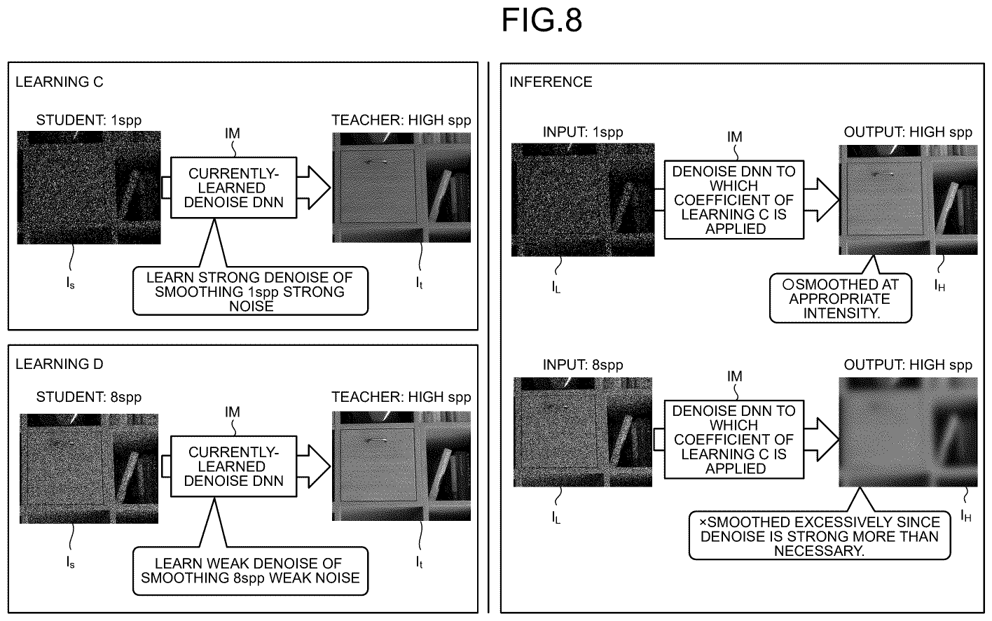

FIG. 8 is a view for describing features of learning and inference in denoise.

Intensity of noise generated by ray tracing varies depending on magnitude of spp. In the learning of the denoise, the intensity of smoothing by the denoise changes depending on the intensity of the noise of the student image Iₛ. Thus, when the spp value of the student image at the time of learning is different from the spp value of the input image at the time of inference, appropriate denoise is not performed. Thus, the learning data acquisition processing unit 31 makes the spp value of the student image Iₛ match the spp value of the input image of when the external output video is generated from the input image by utilization of the inference model IM.

For example, when an 8-spp low-noise image is input to the DNN that has learned the denoise of a 1-spp high-noise image, excessive smoothing is performed due to the unnecessarily strong denoise. Conversely, when the 1-spp high-noise image is input to the DNN that has learned the denoise of the 8-spp low-noise image, the noise remains without being removed. Thus, in the learning and the inference of the denoise, it is necessary to make the spp value of the student image Iₛ at the time of learning match the spp value of the input image at the time of inference.

### 4-3. Adjustment of an spp Value by Accumulation of Ray Samples

FIG. 9 to FIG. 12 are views for describing an adjustment method of the spp value by accumulation of the ray samples.

As described above, in the learning of the denoise, the spp value of the student image Iₛ is made to match the spp value of the input image at the time of the inference. In the learning of the super-resolution processing, the ratio of the resolution of the student image Iₛ and that of the teacher image Iₜ is made to match the magnification of the super-resolution. In the present disclosure, such a condition is adjusted by the accumulation amount of ray samples and the size of the pixel grid.

As illustrated in FIG. 9, even when the number of ray samples SM is the same, when the definition of the pixel grid GD (size of the pixel PX) is made to vary, the resolution and spp value of the image change. In the example of FIG. 9, three images of 4K1spp, 2K4spp, and 1K16spp can be generated from the same ray sample data R_{S}. The three images are equivalent images in a sense that the number of ray samples SM is equal. The learning data acquisition processing unit 31 can define the pixel grid GD having an appropriate size in such a manner as to acquire the desired resolution and spp value.

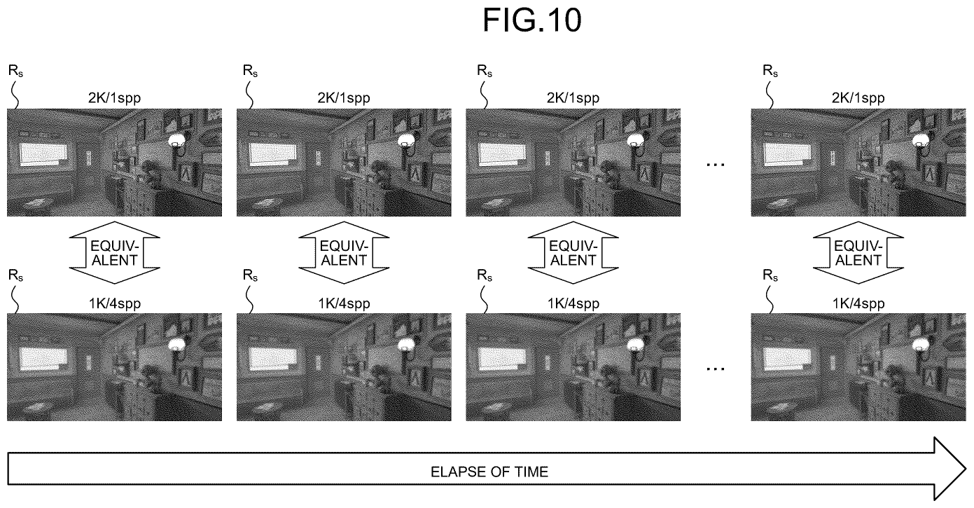

The spp value can also be adjusted by accumulation of the ray sample data R_{S} of a plurality of frames related to the same viewpoint. In the example of FIG. 10, an image of a same scene is generated over a plurality of frames in a state in which a viewpoint of rendering (position and direction of a camera) is fixed. In the example of FIG. 10, the resolution of the viewport is 2K. Thus, the rendered image I_{V} for the viewport is generated under a rendering condition of 2K1spp, for example.

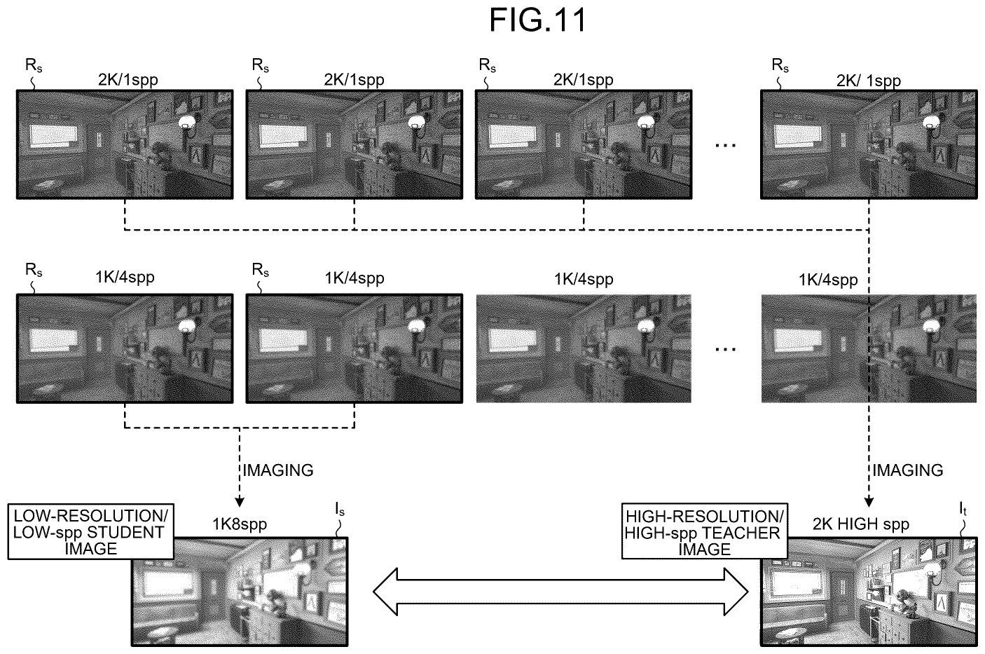

2K1spp is equivalent to 1K4spp. In a case where the student image Iₛ or the teacher image Iₜ requires the spp value larger than 4 spp, the learning data acquisition processing unit 31 can accumulate ray samples of a plurality of frames related to the same viewpoint and realize the number of ray samples larger than 4 spp. In the example of FIG. 11, two frames of the ray sample data R_{S} of 2K1spp are accumulated and the student image Iₛ of 1K8spp is generated.

In a case where it is desired to make the spp value smaller than 4 spp as in 1K3spp, the pixel value is calculated with one ray sample SM among the four ray samples SM included in the one pixel PX being excluded. For the teacher image Iₜ, 2K high spp is realized by accumulation of a large number of pieces of ray sample data R_{S} of 2K1spp.

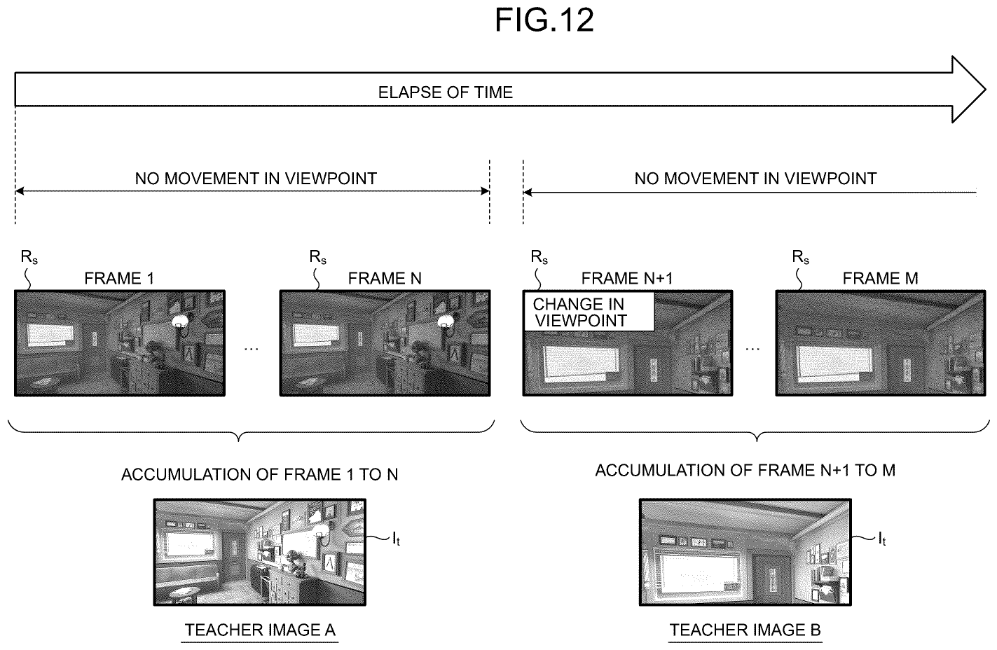

In the learning of the denoise, the spp value of the teacher image Iₜ is not specifically limited. For the teacher image Iₜ, performance of the denoise becomes higher as the spp value becomes higher. Thus, in a case of generating the teacher image Iₜ, it is desirable to increase the number of pieces of accumulated ray sample data R_{S} as much as possible. In the example of FIG. 12, the ray sample data R_{S} of all frames until the viewpoint of the rendering is switched is accumulated and the teacher image Iₜ is generated.

In a case where the rays RY are not sufficiently accumulated, for example, in a case where the viewpoint is switched in short time, the teacher image Iₜ having high spp cannot be acquired. In this case, a denoiser for a teacher image may be used in such a manner that the teacher image Iₜ can be acquired even with short accumulation time. For example, in a case where the degree of accumulation of the ray sample data R_{S} does not satisfy the allowable standard (required performance of the denoise) of when the teacher image Iₜ is generated, the learning data acquisition processing unit 31 denoises the image acquired by the accumulation of the ray sample data R_{S} and generates the teacher image Iₜ. The denoiser for the teacher image may be a general-purpose denoiser, and being a DNN or a non-DNN is not a matter. The denoiser for the teacher image may operate in the background, or a result of the denoise may be displayed on the viewport as a low-noise video.

### 4-4. Large Number of Student Images Generated from a Same Scene

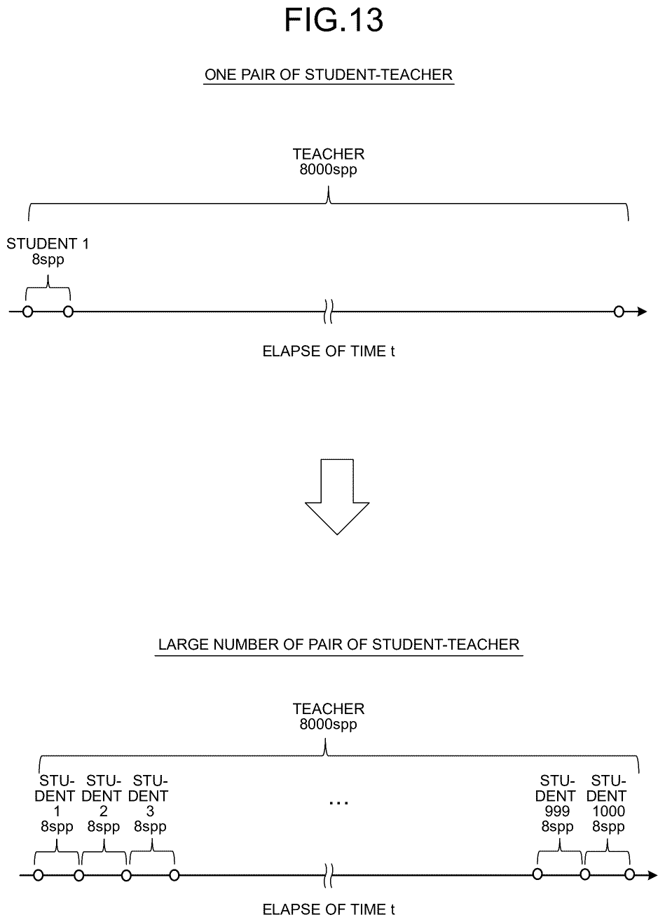

FIG. 13 is a view for describing a method of generating a large number of the student images Iₛ from a same scene.

In an upper example of FIG. 13, a pair of the student image Iₛ and the teacher image Iₜ is generated from the ray tracing data R_{T} in a certain period without a variation in the viewpoint. However, as in a lower example of FIG. 13, when a data region used for generation of the student image Iₛ is made to vary, a plurality of the student images Iₛ can be generated for the one teacher image Iₜ.

For example, the learning data acquisition processing unit 31 selects a plurality of different combinations of ray sample data R_{S} from a plurality of pieces of the ray sample data R_{S} used to generate the teacher image Iₜ. The learning data acquisition processing unit 31 generates the student image I_{S} for each of the selected combinations of the ray sample data R_{S}. Since a noise pattern of the ray tracing is random, it is possible to learn noise patterns of the more student images I_{S} by using the above method.

### 4-5. Inference Processing Using a Learning Result

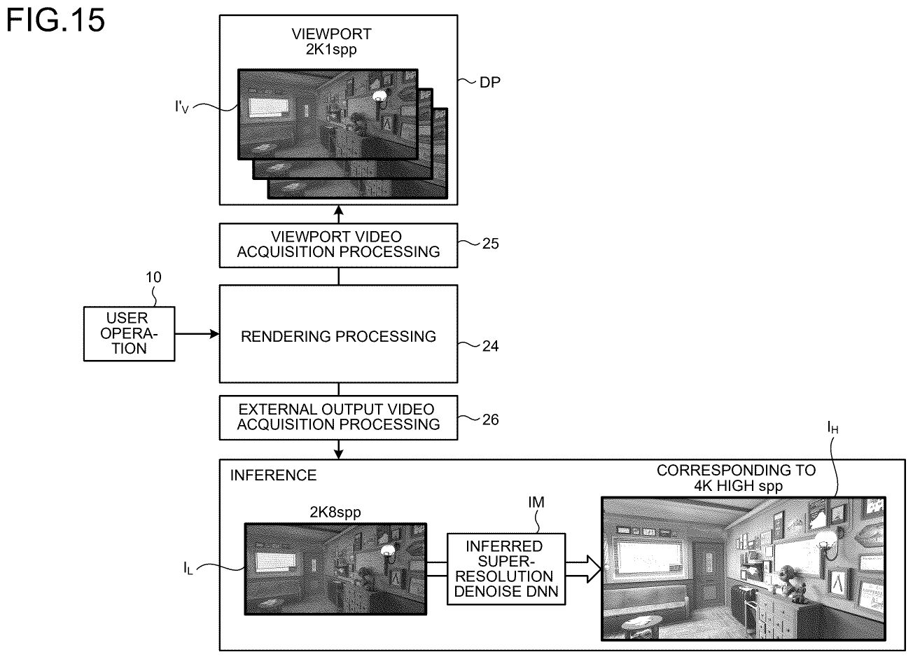

FIG. 14 and FIG. 15 is views illustrating an example of learning and inference using rendered data for the viewport. The following processing is performed in parallel with processing of generation and display of the viewport video.

The learning data acquisition processing unit 31 accumulates the sequentially rendered ray sample data R_{S} (2K1spp) for the viewport, and generates a teacher image Iₜ (2K high spp) having high spp with less noise. The learning data acquisition processing unit 31 accumulates the ray sample data R_{S} at the degree of accumulation lower than that of the teacher image Iₜ and generates the student image Iₛ having the resolution and spp lower than those of the teacher image Iₜ (1K8spp). The resolution and the spp value of the student image Iₛ and the resolution of the teacher image Iₜ are set on the basis of the learning condition PT.

The online learning processing unit 29 performs learning of the denoise and the super-resolution processing by using the generated student image Iₛ and teacher image Iₜ. In the example of FIG. 14, magnification being 2 is learned as the super-resolution processing, and noise removal on an 8-spp input image is learned as the denoise. As illustrated in FIG. 15, when a video of 2K8spp is rendered and is input to the inference model IM after learning, a video of 4K high spp is acquired.

### 4-6. Generation Flow of Learning Data

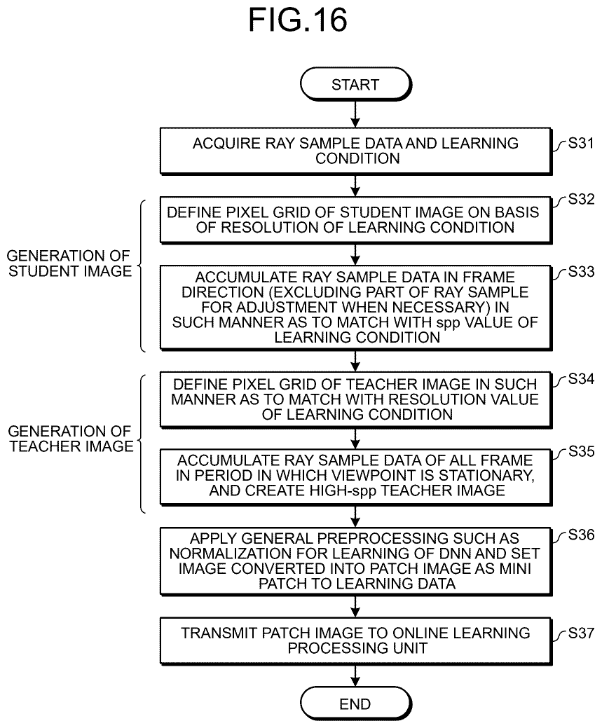

FIG. 16 is a flowchart illustrating an example of a generation flow of the learning data.

The learning data acquisition processing unit 31 acquires the ray sample data R_{S} and the learning condition P_{T} from the rendering processing unit 24 and the learning/inference condition acquisition processing unit 32 (Step S31). The learning data acquisition processing unit 31 defines the pixel grid GD of the student image Iₛ on the basis of the resolution of the student image Iₛ defined in the learning condition P_{T} (Step S32).

The learning data acquisition processing unit 31 accumulates the ray sample data R_{S} in the frame direction in such a manner as to match the spp value of the student image Iₛ defined in the learning condition P_{T}, and generates the student image Iₛ (Step S33). When all the ray samples SM are accumulated, in a case where a defined spp value (defined value) is exceeded, the student image Iₛ is generated with one or more ray samples SM that exceed the defined value being excluded.

The learning data acquisition processing unit 31 defines the pixel grid GD of the teacher image Iₜ on the basis of the resolution of the teacher image Iₜ defined in the learning condition P_{T} (Step S34). The learning data acquisition processing unit 31 accumulates the ray sample data R_{S} of all frames in a period in which the viewpoint is stationary, and generates the teacher image Iₜ having high spp (Step S35).

The learning data acquisition processing unit 31 applies general preprocessing such as normalization to the generated student image Iₛ and teacher image Iₜ. The learning data acquisition processing unit 31 outputs the student image Iₛ and the teacher image Iₜ converted into patch images as a mini-batch to the online learning processing unit 29 as the learning data (Step S36 and S37).

### 5. AUTOMATIC SETTING OF A LEARNING CONDITION AND AN INFERENCE CONDITION

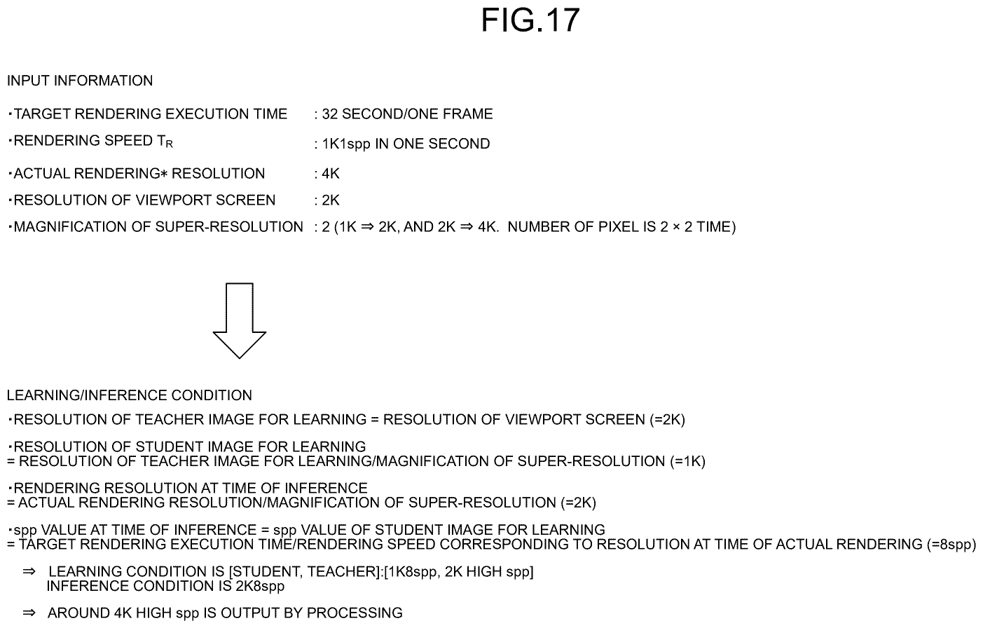

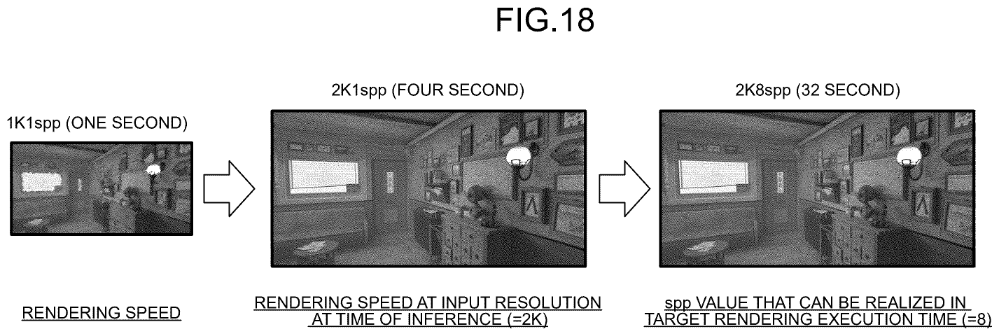

FIG. 17 and FIG. 18 are views for describing a setting method of the learning condition P_{T} and the inference condition P_{I}.

The learning data acquisition processing unit 31 can set the learning condition P_{T} and the inference condition P_{I} on the basis of the target rendering execution time and the rendering speed T_{R}. For example, the learning condition P_{T} and the inference condition P_{I} are set as follows in consideration of the rendering set value P_{R}. In the example of FIG. 17, the following conditions are set by the rendering set value P_{R}.
Target rendering execution time: 32 seconds/frame
Rendering speed T_{R}: 1K1spp/second
Resolution of actual rendering (resolution of external output video): 4K
Resolution of viewport screen: 2K
Magnification of super-resolution: 2

First, the resolution of the input image input to the inference model IM at the time of inference is acquired as a value acquired by division of the resolution of the actual rendering by the magnification of the super-resolution. In the above example, since the resolution of the actual rendering is 4K and the magnification of the super-resolution is 2, the resolution of the input image to the inference model IM is determined to be 2K.

The spp value of the input image at the time of the inference is calculated from the target rendering execution time and the rendering speed T_{R}. In the above example, the ray samples SM the number of which corresponds to 1K1spp are acquired per second. From the above calculation, the resolution of the input image is determined to be 2K. Since 2K has four times the number of pixels as compared with 1K, the number of ray samples SM needs to be four times 1K1spp in a case where a 2K image is generated at 1 spp. Thus, rendering takes 4 seconds.

According to the target rendering execution time, time

of 32 seconds can be allocated to generate the input image of one frame. Since it takes 4 seconds to generate 2K1spp, the ray samples SM of 8 times 2K1spp can be acquired in 32 seconds. That is, rendering of 2K8spp can be performed in 32 seconds. Thus, the inference condition P_{I} (resolution and spp value of the input image) that can achieve the target rendering execution time is determined to be 2K8spp.

The resolution of the teacher image Iₜ for learning is determined by the resolution of the viewport video (=2K). This is because the resolution of the teacher image Iₜ has to match the resolution of the viewport video since the ray sample SM is thinned out in the spatial direction to create the student image Iₛ with low resolution. Thus, the resolution of the teacher image Iₜ is determined to be 2K. The resolution of the student image Iₛ is a value acquired by division of the resolution of the teacher image Iₜ by the magnification of the super-resolution processing. This is because the learning of the super-resolution processing is to learn the magnification. Thus, the resolution of the student image Iₛ is determined to be 1K.

The spp value of the student image Iₛ needs to match the spp value of the input image at the time of the inference. This is because appropriate denoise is not performed on the input image when noise intensity at the time of the learning does not match noise intensity of the input image at the time of the inference since the spp value is directly connected to the intensity of the noise. From the above calculation, the spp value of the input image is determined to be 8. Thus, the spp value of the student image Iₛ is also determined to be 8. Since it is better that the spp value of the teacher image Iₜ is larger, it is desirable to accumulate the ray sample data R_{S} as much as possible in a period in which the scene is the same (there is no variation in the viewpoint). Thus, the spp value of the teacher image Iₜ is not specifically limited as long as the allowable standard (required performance of the denoise) is satisfied.

As described above, the learning condition P_{T} is determined as follows.
Student image Iₛ: 1K8spp
Teacher image Iₜ: 2K high spp

When the inference model IM is learned under such a learning condition P_{T}, it is possible to acquire the output image I of 4K high spp within the target rendering execution time at the time of actual rendering.

### 6. HARDWARE CONFIGURATION EXAMPLE

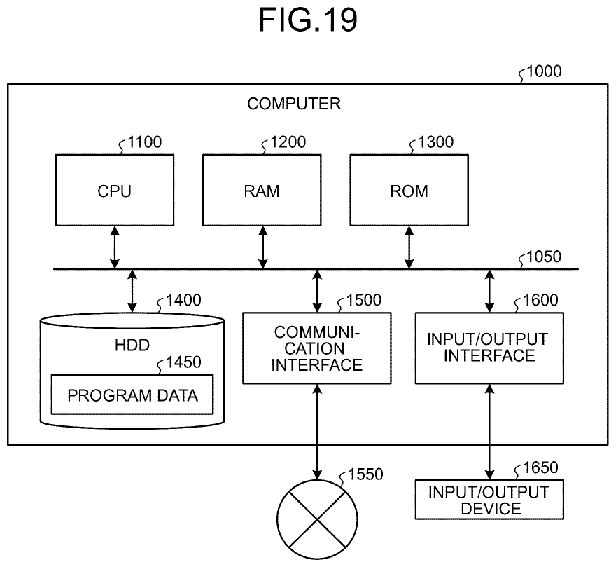

FIG. 19 is a view illustrating a hardware configuration example of the renderer 30.

Information processing of the renderer 30 is realized by, for example, a computer 1000. The computer 1000 includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of programs (program data 1450) stored in the ROM 1300 or the HDD 1400, and controls each unit. For example, the CPU 1100 expands the programs, which are stored in the ROM 1300 or the HDD 1400, in the RAM 1200 and executes processing corresponding to the various programs.

The ROM 1300 stores a boot program such as a basic input output system (BIOS) executed by the CPU 1100 during activation of the computer 1000, a program that depends on hardware of the computer 1000, and the like.

The HDD 1400 is a computer-readable non-transitory recording medium that records the programs executed by the CPU 1100, data used by the programs, and the like in a non-transitory manner. Specifically, the HDD 1400 is a recording medium that records an information processing program according to the embodiment as an example of the program data 1450.

The communication interface 1500 is an interface with which the computer 1000 is connected to an external network 1550 (such as the Internet). For example, the CPU 1100 receives data from another equipment or transmits data generated by the CPU 1100 to another equipment via the communication interface 1500.

The input/output interface 1600 is an interface to connect an input/output device 1650 and the computer 1000. For example, the CPU 1100 receives data from an input device such as a keyboard or a mouse via the input/output interface 1600. Furthermore, the CPU 1100 transmits data to an output device such as a display device, speaker, or printer via the input/output interface 1600. Also, the input/output interface 1600 may function as a medium interface that reads a program or the like recorded on a predetermined recording medium (medium). The medium is, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like.

For example, in a case where the computer 1000 functions as the renderer 30 according to the embodiment, the CPU 1100 of the computer 1000 realizes a function each of above-described units by executing the information processing program loaded on the RAM 1200. In addition, the HDD 1400 stores the information processing program, various models, and various kinds of data according to the present disclosure. Note that the CPU 1100 reads the program data 1450 from the HDD 1400 and performs execution thereof. However, these programs may be acquired from another device via the external network 1550 in another example.

### 7. EFFECT

The renderer 30 includes the learning data acquisition processing unit 31. The learning data acquisition processing unit 31 sequentially acquires, from the rendering processing unit 24, the ray sample data generated by the rendering processing unit 24 by the ray simulation. The learning data acquisition processing unit 31 reconstructs the ray sample data Rₛ sequentially acquired from the rendering processing unit 24 and generates learning data of the inference model IM. The learning data includes the student image Iₛ and the teacher image Iₜ for learning of the inference model IM. In the information processing method of the present disclosure, processing of the renderer 30 is executed by the computer 1000. A computer-readable non-transitory storage medium of the present disclosure stores a program of causing the computer 1000 to realize the processing of the renderer 30.

According to this configuration, the learning data is generated by reconstruction of the ray sample data R_{S} of the content during the rendering. Since new rendering for generating the learning data is unnecessary, the calculation cost for the learning can be controlled.

The learning data acquisition processing unit 31 makes the resolution of the student image Iₛ and that of the teacher image Iₜ different by making the size of the pixel grid GD applied to the ray sample data R_{S} vary between the student image Iₛ and the teacher image Iₜ.

According to this configuration, the inference model IM that performs the super-resolution processing at arbitrary magnification is generated.

The learning data acquisition processing unit 31 makes the spp values of the student image Iₛ and the teacher image Iₜ different by making the degree of accumulation of the ray sample data R_{S} in the frame direction vary between the student image Iₛ and the teacher image Iₜ.

According to this configuration, the inference model IM having arbitrary denoise performance is generated.

In a case where the degree of accumulation of the ray sample data R_{S} does not satisfy the allowable standard of when the teacher image Iₜ is generated, the learning data acquisition processing unit 31 generates the teacher image Iₜ by denoising of the image acquired by the accumulation of the ray sample data R_{S}.

According to this configuration, even in a case where sufficient ray sample data R_{S} cannot be accumulated in the frame direction, for example, when the viewpoint of rendering is switched in short time, the high-quality teacher image Iₜ can be acquired.

The learning data acquisition processing unit 31 makes the spp value of the student image Iₛ match the spp value of the input image of when the external output video is generated from the input image by utilization of the inference model IM.

According to this configuration, the inference model IM having appropriate denoise performance corresponding to a state of the noise of the input image is generated.

For example, the learning data acquisition processing unit 31 selects a plurality of different combinations of the ray sample data R_{S} from the plurality of pieces of ray sample data R_{S} used to generate the teacher image Iₜ. The learning data acquisition processing unit 31 generates the student image Iₛ for each of the selected combinations of the ray sample data R_{S}.

According to this configuration, a plurality of the student images Iₛ is generated for the one teacher image Iₜ. Since the noise pattern of the ray tracing is random, various noise patterns can be learned by generation of more student images Iₛ.

The renderer 30 includes the learning/inference condition acquisition processing unit 32. The learning/inference condition acquisition processing unit 32 calculates the spp value of the input image on the basis of the rendering speed T_{R} and the target rendering execution time.

According to this configuration, the appropriate inference condition P_{I} that can achieve the target rendering execution time is acquired.

The renderer 30 includes the online learning processing unit 29. The online learning processing unit 29 uses a part of the learning data as the evaluation data. The online learning processing unit 29 evaluates the appropriateness of the learning on the basis of a comparison result between an inference image acquired by an input of the student image Iₛ included in the evaluation data to the inference model IM and the teacher image It corresponding to the inference image.

According to this configuration, a progress status of the learning is quantitatively determined.

On the basis of the learning data acquired by reconstruction of the ray sample data R_{S}, the online learning processing unit 29 performs fine tuning of the general-purpose inference model IM learned with the general-purpose data.

According to this configuration, generalization performance for an unknown input is enhanced.

The online learning processing unit 29 extracts, from the learning data, a plurality of student images Iₛ and a plurality of teacher images Iₜ having viewpoint information similar to the viewpoint information used for generation of the external output video. The online learning processing unit 29 performs fine tuning of the inference model IM by preferentially using the extracted plurality of student images Iₛ and plurality of teacher images Iₜ.

According to this configuration, the learning result of the inference model IM is easily reflected in the improvement of the image quality of the external output video.

The ray sample data R_{S} is data generated for the viewport video.

According to this configuration, it is possible to perform the generation processing of the viewport video and the generation processing of the learning data while linking the two.

The resolution of the teacher image Iₜ matches the resolution of the viewport video.

According to this configuration, various calculation results acquired in the process of generating the viewport video are effectively used for generating the learning data.

Note that the effects described in the present description are merely examples and are not limitations, and there may be another effect.

### SUPPLEMENTARY NOTE

Note that the present technology can also have the following configurations.
(1)

An information processing device comprising: a learning data acquisition processing unit that sequentially acquires ray sample data generated by ray simulation by a ray tracer from the ray tracer, and reconstructs the ray sample data and generates learning data including a student image and a teacher image for learning of an inference model.
(2)

The information processing device according to (1), wherein
the learning data acquisition processing unit makes resolution of the student image and that of the teacher image different by making a size of a pixel grid applied to the ray sample data vary between the student image and the teacher image.
(3)

The information processing device according to (1) or (2), wherein
the learning data acquisition processing unit makes spp values of the student image and the teacher image different by making a degree of accumulation of the ray sample data in a frame direction vary between the student image and the teacher image.
(4)

The information processing device according to (3), wherein
the learning data acquisition processing unit generates the teacher image by denoising an image acquired by accumulation of the ray sample data in a case where the degree of accumulation of the ray sample data in generation of the teacher image does not satisfy an allowable standard.
(5)

The information processing device according to (3) or (4), wherein
the learning data acquisition processing unit makes the spp value of the student image match an spp value of an input image of when an external output video is generated from the input image by utilization of the inference model.
(6)

The information processing device according to (5), wherein
the learning data acquisition processing unit selects a plurality of different combinations of the ray sample data from a plurality of pieces of the ray sample data used for generation of the teacher image, and generates the student image for each of the selected combinations of the ray sample data.
(7)

The information processing device according to (5) or (6), wherein
a learning/inference condition acquisition processing unit that calculates the spp value of the input image on a basis of a rendering speed and target rendering execution time.
(8)

The information processing device according to any one of (1) to (7), further comprising
an online learning processing unit that uses a part of the learning data as evaluation data and evaluates appropriateness of learning on a basis of a result of comparison between an inference image acquired by an input of the student image included in the evaluation data to the inference model and the teacher image corresponding to the inference image.
(9)

The information processing device according to (8), wherein
the online learning processing unit performs fine tuning of a general-purpose inference model learned with general-purpose data on a basis of the learning data acquired by reconstruction of the ray sample data.
(10)

The information processing device according to (9), wherein
the online learning processing unit extracts, from the learning data, a plurality of the student images and a plurality of the teacher images having viewpoint information similar to viewpoint information used for generation of an external output video, and performs fine tuning of the inference model by preferentially using the extracted plurality of student images and plurality of teacher images.
(11)

The information processing device according to any one of (1) to (10), wherein
the ray sample data is data generated for a viewport video.
(12)

The information processing device according to (11), wherein
resolution of the teacher image matches resolution of the viewport video.
(13)

An information processing method executed by a computer, the method comprising: sequentially acquiring ray sample data generated by ray simulation by a ray tracer from the ray tracer, and reconstructing the ray sample data and generating learning data including a student image and a teacher image for learning of an inference model.
(14)

A computer-readable non-transitory storage medium that stores a program causing a computer to execute sequentially acquiring ray sample data generated by ray simulation by a ray tracer from the ray tracer, and reconstructing the ray sample data and generating learning data including a student image and a teacher image for learning of an inference model.

### REFERENCE SIGNS LIST

24 RENDERING PROCESSING UNIT (RAY TRACER)
29 ONLINE LEARNING PROCESSING UNIT
31 LEARNING DATA ACQUISITION PROCESSING UNIT
32 LEARNING/INFERENCE CONDITION ACQUISITION PROCESSING UNIT
30 RENDERER (INFORMATION PROCESSING DEVICE)
GD PIXEL GRID
IM INFERENCE MODEL
Iₛ STUDENT IMAGE
Iₜ TEACHER IMAGE
R_{S} RAY SAMPLE DATA
T_{R} RENDERING SPEED

1. An information processing device comprising: a learning data acquisition processing unit that sequentially acquires ray sample data generated by ray simulation by a ray tracer from the ray tracer, and reconstructs the ray sample data and generates learning data including a student image and a teacher image for learning of an inference model.

2. The information processing device according to claim 1, wherein
the learning data acquisition processing unit makes resolution of the student image and that of the teacher image different by making a size of a pixel grid applied to the ray sample data vary between the student image and the teacher image.

3. The information processing device according to claim 1, wherein
the learning data acquisition processing unit makes spp values of the student image and the teacher image different by making a degree of accumulation of the ray sample data in a frame direction vary between the student image and the teacher image.

4. The information processing device according to claim 3, wherein
the learning data acquisition processing unit generates the teacher image by denoising an image acquired by accumulation of the ray sample data in a case where the degree of accumulation of the ray sample data in generation of the teacher image does not satisfy an allowable standard.

5. The information processing device according to claim 3, wherein
the learning data acquisition processing unit makes the spp value of the student image match an spp value of an input image of when an external output video is generated from the input image by utilization of the inference model.

6. The information processing device according to claim 5, wherein
the learning data acquisition processing unit selects a plurality of different combinations of the ray sample data from a plurality of pieces of the ray sample data used for generation of the teacher image, and generates the student image for each of the selected combinations of the ray sample data.

7. The information processing device according to claim 5, wherein
a learning/inference condition acquisition processing unit that calculates the spp value of the input image on a basis of a rendering speed and target rendering execution time.

8. The information processing device according to claim 1, further comprising
an online learning processing unit that uses a part of the learning data as evaluation data and evaluates appropriateness of learning on a basis of a result of comparison between an inference image acquired by an input of the student image included in the evaluation data to the inference model and the teacher image corresponding to the inference image.

9. The information processing device according to claim 8, wherein
the online learning processing unit performs fine tuning of a general-purpose inference model learned with general-purpose data on a basis of the learning data acquired by reconstruction of the ray sample data.

10. The information processing device according to claim 9, wherein
the online learning processing unit extracts, from the learning data, a plurality of the student images and a plurality of the teacher images having viewpoint information similar to viewpoint information used for generation of an external output video, and performs fine tuning of the inference model by preferentially using the extracted plurality of student images and plurality of teacher images.

11. The information processing device according to claim 1, wherein
the ray sample data is data generated for a viewport video.

12. The information processing device according to claim 11, wherein
resolution of the teacher image matches resolution of the viewport video.

13. An information processing method executed by a computer, the method comprising: sequentially acquiring ray sample data generated by ray simulation by a ray tracer from the ray tracer, and reconstructing the ray sample data and generating learning data including a student image and a teacher image for learning of an inference model.

14. A computer-readable non-transitory storage medium that stores a program causing a computer to execute sequentially acquiring ray sample data generated by ray simulation by a ray tracer from the ray tracer, and reconstructing the ray sample data and generating learning data including a student image and a teacher image for learning of an inference model.
